(19) United States
(12) Patent Application Publication
(10) Pub. No.: US 2004/0186213 A1
(43) Pub. Date: Sep. 23, 2004

(54) Alloy blends of polyurethane and rubber

(76) Inventors: Donald Allan Sandusky, Wilmington, DE (US); Edwin L. McInnis, Lincoln University, PA (US)

Correspondence Address: CONNOLLY BOVE LODGE & HUTZ, LLP, P O BOX 2207, WILMINGTON, DE, 19899, US

(21) Appl. No.: 10/802,137

(22) Filed: Mar. 17, 2004

Related U.S. Application Data
(60) Provisional application No. 60/455,674, filed on Mar. 18, 2003.

(51) Int. Cl. C08K 3/34

(52) U.S. Cl. 524/445

(57) ABSTRACT

The present invention relates to a rubber formulation suitable for making barrier articles, such as inflatable sports balls or bicycle tubes, that resist the passage of gases, such as air, particularly as applicable to tennis balls, and more particularly to the rubber formulation which contains substantially amorphous, millable polyurethane alloyed with natural and/or synthetic rubbers.

### CROSS-REFERENCE TO RELATED APPLICATION

This application claims benefit of the priority of Provisional Application No. 60/455,674 filed Mar. 18, 2003.

### FIELD OF THE INVENTION

The present invention relates to a rubber formulation suitable for making barrier articles, such as inflatable sports balls or bicycle tubes that resist the passage of gases, such as air, particularly as applicable to tennis balls and more particularly to the rubber formulation which contains substantially amorphous, millable polyurethane alloyed with natural and/or synthetic rubbers.

### BACKGROUND OF THE INVENTION

In rubber compositions for producing pressurized sports articles, such as hollow core tennis balls or bladders for soccer balls, volleyballs, basketballs or bicycle innertubes, vulcanizable natural or synthetic butyl rubbers and combinations thereof are commonly employed. These cured rubber components are fabricated with conventional rubber milling and molding methods and form products that are sufficient in some properties but are typically deficient in either air retention or elastic properties.

Bladders, or “cores,” made from natural rubber can suffer from deficient gas barrier performance, undesirably high rubber aging, and undesirable rubber hysteresis attributes. Natural rubber is known to age harden over time and suffers from high hysteresis in that the rubber does not readily recover its pre-stretched elastic properties. Moreover, because of the deficient gas barrier performance of natural rubber, the pressure gradient between the pressurized inside and ambient outside, causes air to gradually diffuse from balls made from natural rubber. Loss of air ultimately renders these balls unsuitable for play. As a result of undesirable rubber aging and poor rubber hysteresis properties, the bounce and feel of these balls tends to decay substantially within the normal use timeframe.

In contrast, balls with conventional synthetic butyl rubber cores tend to have superior air retention properties. However, they are significantly deficient in resilience which negatively affects their bounce, control, and feel. Deficiencies in resilience exacerbates vulnerability of articles such as innertubes to puncture damage.

The resiliency of the rubber core and the internal air pressure impart to tennis balls rebound which makes the tennis ball quickly recover it's spherical shape after impact. Because a tennis ball is deformed so dramatically, and its core is so thick, the reliability of both internal gas pressure retention and the rubber core elastic properties become simultaneously important.

Tennis balls conventionally comprise a hollow rubber core with a felt cover permanently adhered thereto. Since the early 1920's, most tennis balls have been pressurized to about two atmospheres absolute. However, because of pressure differential between inside the core and outside, the air gradually diffuses to the outside, causing “softening” of the ball which results in loss of good bounce and playability. Hence, it is a common practice to pack the tennis balls in air-tight pressurized cans in order to maintain internal pressure in the balls until at least the start of the play.

However, once a tennis ball is removed from its pressurized can, air pressure loss starts and thereby softening of the ball resumes and play consistency continues to deteriorate. As a result, tennis balls are discarded frequently after just a few games.

An illustrative example for the difference between natural rubber and butyl rubber bladders is observed in the state of the art butyl soccer balls and state of the art natural rubber soccer balls. Butyl soccer balls are far more common than natural rubber soccer balls because butyl rubbers superior air retention is more broadly valued than the superior playability of natural rubber soccer balls. On the other hand, in the premium performance soccer balls, natural latex rubber bladders are employed for superior foot-speed and control, but at a significant air retention penalty. The poor air retention of natural rubber soccer balls becomes an even bigger problem on a long hot summer day.

Several approaches have been used to reduce air leakage from tennis balls. U.S. Pat. No. 6,030,304 describes a pressureless tennis ball where the core is formed from a compound containing rubber and a plastomer defined as a copolymer of ethylene and one or more alkenes. U.S. Pat. No. 5,225,258 describes another pressureless hollow ball where the core is formed from a rubber compound containing a specific polybutadiene composition. Another patent U.S. Pat. No. 4,145,045 describes yet another pressureless hollow ball based on an elastomeric composition including natural rubber, cis 1,4-polybutadiene, and a copolymer of ethylene. However, these airless tennis balls do not have the same “feel” and bounce of the pressurized balls, and therefore these pressureless balls have not been adopted by tennis pros.

Another difficult to apply approach is to employ a flexible barrier spray-coated inside the bladder or core halves.

Another approach is to employ gasses that permeate rubber more slowly than air. Two such gases are nitrogen and sulfur hexafluoride. However, each of these is expensive and cumbersome to employ. In the case of sulfur hexaflouride, internal pressure actually increases with time due to pneumatic pumping of air molecules from the outside the ball into the inside of the ball driven by the partial pressure gradient and limited by the relatively slow permeability of the sulfur hexaflouride. (Described in U.S. Pat. No. 4,340,626).

Another approach taken by some investigators to manage air pressure in the tennis balls has been to insert valve into the tennis balls where the tennis ball is pressurized at the play site, as described in U.S. Pat. No. 4,327,912. Conceptually, one can imagine pressurizing the balls frequently with air with an on site air pump. This is not seen as a convenient operation to perform during the play. Moreover, these tennis balls, which are made of a molded spherical shell of elastomeric material, such as natural rubber or artificial rubber suffer from the same softening of the balls due to air leakage in between the pumping events.

The tennis industry has long been seeking an effective, low cost improvement for tennis ball longevity and consistency of play. The subject invention delivers that effective solution to the tennis industry.

### SUMMARY OF THE INVENTION

An aspect of the present invention provides novel formulations for hollow or inflatable rubber articles, such as tennis balls, basket balls, volleyballs, soccer balls, inner tubes, and tires having substantially improved barrier properties.

An aspect of the present invention provides novel MPU/rubber alloys that provide enhanced barrier properties along with good balance of other mechanical properties, such as resiliency, strength etc.

A further aspect of the present invention provides novel MPU/rubber formulations which can be used to make barrier articles without requiring new manufacturing equipment or process lines.

An aspect of the present invention provides a composition of matter comprising millable polyurethane (MPU) alloyed with rubber. A further aspect provides the MPU is substantially amorphous.

An aspect of the present invention provides a composition of matter having a permeability to oxygen not greater than about 5.5 cm³ cm/cm² seconds Pascal 10⁻¹³ at 25° C.

An aspect of the present invention provides an MPU/rubber alloy wherein the millable polyurethane comprises an ether glycol selected from the group consisting of polytetramethylene ether glycol, polyester ether glycols, and polypropylene ether glycols. A further aspect provides the rubber is natural or synthetic polyisoprene, polybutadiene, and blends thereof.

An aspect of the present invention provides rubber formulations surprisingly having at least 2 to 3-fold greater air retention along with greater than 3 Mpa tensile strength, greater than 10% resiliency and hysteresis responses characterized by tangent delta less than 1.5.

Furthermore, alloys of this novel formulation exhibit an inflection point, in curves of oxygen permeability as a function of fractional MPU composition, at about 40% millable Polyurethane/60% natural or synthetic rubber

A better understanding of further aspects, advantages, features, properties, and relationships of the invention will be obtained with the additional detail description and examples appended below.

### BRIEF DESCRIPTION OF DRAWINGS

FIG. 1 is a graph illustrating the dependence of oxygen permeability as a function of percent MPU.

### DETAILED DESCRIPTION OF THE INVENTION

To help fully comprehend the scope of the invention, definitions and detailed descriptions are provided herein so that the meaning of each term will become clear.

Polyurethanes are a class of materials which are prepared typically by combining three classes of precursor subunits: (1) one or more long chain polyols; (2) one or more polyisocyanates; and (3) one or more chain extenders, short chain molecules containing two or more active hydrogen-containing groups capable of reacting with isocyanate groups.

Long-chain polyols (1) are polyhydroxy compounds derived from polyesters, polyethers, polycarbonates, or mixtures thereof. Suitable polyethers include polyethylene glycols, polypropylene glycols, polytetramethylene glycols, or copolymers of these materials. Suitable polyesters may be prepared from dicarboxylic acids having 2 to 12 carbon atoms and polyhydric alcohols containing 2 to 10 carbons which contain two or more active hydroxyl groups per molecule.

Polyisocyanates (2) may be alipahatic, cycloaliphatic, or aromatic such as hexanediisocyanate, isophorone diisocyanate, cyclohexane diisocyanate, diphenylmethane diisocyanate, phylene diisocyanate, napthalene diisocyanate, as well as tri or higher isocyanates, containing two or more reactive isocyanate groups per molecule.

Chain-extenders (3) are short chain molecules containing two or more active hydrogen compounds capable of reacting with isocyanate groups. Examples of chain-extenders include, but are not limited to, glycerol monoallylether, trimethylene glycol monoallyl ether, glycerol monolineolate, and similar compounds. The various subunits may be combined sequentially or simultaneously in processes that are known to the art.

Polyurethanes are conventional to the art and may be synthesized by a number of known procedures whereby compounds of types 1, 2, and 3 are combined under controlled conditions of temperature and mixing. Polyurethanes may be substantially crystalline, semi-crystalline or substantially amorphous according to the nature and relative proportion of the three subunit types.

“Amorphous” regions, equivalently known as “soft segments,” or “soft blocks,” are contributed by the long-chain polyol (1). “Crystalline” regions, equivalently known as “hard segments,” or “hard blocks,” are contributed by the combination of the polyisocyanates (2) and the chain-extender (3).

Polyurethanes can behave as elastomers or as rigid, hard thermosets. The stiffness and rigidity of the polymer typically increases as the relative percentage of hard block units increases. Further, as the symmetry and linearity of the hard block units increases, there is an increasing tendency of these units to form domains separate from the soft blocks. Hard block domains are characterized by strong intermolecular attractions and are referred to as crystalline since heat is necessary to disrupt them. Hard block domains melt and disassociate over defined temperature ranges and they are characterized using techniques such as differential scanning calorimetry (DSC). As a sample is heated through a melting transition, a peak is observed in the heat flow curve. The size of this peak is proportional to the crystalline content of the sample. A substantial absence of a peak can be taken as an indication that the polyurethane is amorphous, that only a minimal amount, less than about 5% crystallinity is present.

The term “substantially amorphous polyurethane” comprehends a polyurethane having less than about 5% crystallinty as determined by DSC or similar technique. Moreover, the term comprehends a polyurethane synthesized using essentially no polar or symmetrical chain extenders (3).

The term “millable polyurethane” ( MPU ) comprehends polyurethane materials can be processed in conventional rubber equipment (often referred to as “milling”) and MPU may be either amorphous or may have some crystallinity in the range of about 0-5%, as determined by DSC or by an equivalent technique.

Millable amorphous polyurethanes are typically made by process whereby a millable polyurethane (MPU) gum is formed, subsequently crosslinked, and filled with carbon, clay, silica or similar fillers known in the trade. MPU is generally lower in molecular weight than typical polyurethanes (about 30,000 vs. 60,000 to 100,000 gms/mol). MPU also contains chemical groups which can react with the curatives and accelerants typically used in conventional rubber processing. Typical MPU compositions consist of polyol(s) (1) and polyisocyanate(s) (2) with only small amounts of short chain diol(s) (3). Typically the short chain diol is nonsymmetrical and contains chemical groupings suitable for reaction with the rubber crosslinker(s). A typical compound used is glycerol monoallyl ether (GAE).

In order to limit the molecular weight and reduce the viscosity of the final MPU sufficiently to make the gum processable on conventional rubber processing equipment, the ratio of polyol plus short chain glycol to polyisocyanate is greater than 1 (i.e., [(1)+(3)]/(2)>1). Such monomer ratios result in the formation of little or no symmetrical hardblock in the finished MPU. The elastomer so formed is essentially, or substantially, amorphous. The MPU contains less than about 5% crystallinity as evidenced by the substantial absence of hard segment melting transitions in a DSC spectrum.

Essentially amorphous millable polyurethane ( MPU ) is made by mixing a glycol (polyol 1), such as polytetramethylene ether (PTMEG; Terathane®, E. I. du Pont de Nemours and Company, Wilmington, Del.) in a reactor vessel with a diisocyanate (2) and a short chain functional diol (3). The mix is polymerized to a molecular weight of about 30,000 gm/mol and is allowed to cool and harden. Suitable, but non-limiting polyols (1) include polyester ether glycols, polypropylene ether glycols, and any other glycol that yields millable polyurethane.

The diisocyanate (2) precursor of the MPU of the present invention is preferably, but not limited to, diphenylmethane diisocyanate and toluene diisocyanate. Suitable diisocyanates include, but are not limited to hexanediisocyanate, trimethylhexanediisocyanate, isopherone diisocyanate, cyclohexane diisocyanate, biscyclohexylmethane diisocyanate, norbornane diisocyanate, tetramethylxylene diisocyanate, tolylene diisocyanate, phenylene diisocyanate, napthylene diisocyanate, an dxylylene diisocyante.

The short chain functional diol (chain-extender 3) precursor of the MPU of the present invention is preferabl, but not limited to, glycerol monoallylether and trimethyolpropane monoallyl ether. Suitable short-chain diols include, but are not limited diethylene glycol, tripropylene glycol, and 1,3 butanediol. However, polar chain-extenders, which tend to introduce hard segments, are essentially omitted from the synthesis.

The inventive formulation comprises substantially amorphous MPU because of the unexpected observation that barrier articles, such as air inflatable sports balls or tubes, manifest at least 2-3-fold better air retention as well as other desirable mechanical properties where produced from improved rubber formulations containing at least 10-40% MPU alloyed with rubber. Moreover, polyurethanes containing substantial crystallinity are not mill prossessable and have higher air permeability. Furthermore, the inventive formulations, using MPU meet long-felt unmet needs of the sports balls industry.

The term “rubber” comprehends natural and synthetic polyisoprene, polybutadiene, polyisobutylene, halogenated polybutyl rubbers, and polyethylenepropylenediene monomer rubbers. A preferred rubber is polyisoprene.

As used herein, the term rubber further comprehends rubber with about 50% clay and other additives. A preferred clay is a kaolin, sold as Suprex®. Other additives include, but are not limited to: barium sulfate as a densification filler; silicon dioxide, zinc oxide, zinc stearate, sulfur and N-tert-butyl-2-benzothiazolesulfenamide, as curative agents; phthalate ester process oils; diphenyl guanidine and benzothiazyl disulfide, accelerators; and Thanecure® ZM, a zinc chloride/MBTS complex as a cure activator.

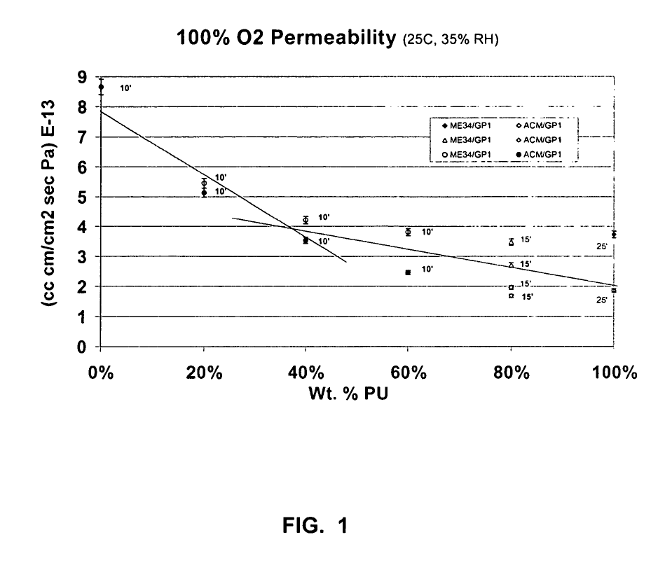

The alloys of the present invention comprise 90 to 10% by weight of MPU and 10 to 90% by weight of rubber and preferably 60 to 40% by weight of MPU and 40 to 60% by weight of rubber. Most preferably, the percentage of MPU should fall in the range depicted in FIG. 1 by the steep line to the left of the inflection point, specifically, in the range of 10-40% (wt %) to keep cost of the alloy material as low as possible. The term “alloy” comprehends an interpenetrating polymer network comprising polyurethane and rubber. The alloys of the present invention are fabricated by combining MPU with a conventional rubber (natural or synthetic) and further compounding additives, curatives, and fillers.

MPU and rubber are mixed in the desired proportions in a banbury, or other suitable industry standard mixer. The mixture is masticated to obtain a good uniform blend and then is calendered or processed by some other industry standard mixing technique. Desired curatives, additives, and fillers are blended during calendaring. The various ingredients are mixed at a temperature that is low enough to prevent curing of rubber. The mixture is calendered for a time sufficient to obtain consistency suitable for use by subsequent molding machines

The term “hysteresis” comprehends the ability of a material to reversibly absorb, store, and return the energy used to deflect or distort the elastomer. Hysteresis is typically measured by techniques including dynamic mechanical analysis and repeated stress-strain cycling.

The term “balance of properties,” comprehends material properties such as strength, modulus, elongation, hardness, resilience, and glass transition temperature a that affect the playability and performance of a sports ball, e.g., tennis balls meet the USTA specifications with respect to deflection, rebound, air pressure, weight, and size.

Oxygen permeability was measured according to ASTM D1434 and a specification less than 5.0 cm³ cm/cm² seconds Pascal×10⁻¹³ was established based on the benchmark established by the measurement of state of the art tennis ball cores as measured in GP-1, GP-2, and GP-4 in examples A, C, and E.

Barrier articles such as tennis balls, other air inflatable sports balls, tubes, and tires, are made by forming the inventive alloy into a desired shape using any of the several techniques suitable for forming rubber articles such as compression molding, transfer molding, calendaring, etc. Barrier articles are formed by curing the inventive MPU/rubber alloys in conventional molding equipment. The subsequent conventional downstream processing, necessary to form tennis balls, such as wrapping the rubber balls with felt, cutting the excess material, polishing, packing etc. before shipping cartons of tennis balls to customers or pro-shops is taught in U.S. Pat. No. 6,030,304; U.S. Pat. No. 5,225,258; and U.S. Pat. No. 5,558,325.

Polyester-based amorphous polyurethanes reduced gas permeability and temperature dependence moreso than did PTMEG-based materials. However, polyester-based materials did not facilitate the balance of properties suitable for tennis balls. Similar results may be expected for polypropylene ether-based amorphous polyurethanes. Consequently, the PTMEG-based MPU provides a coordinated benefit and is preferable for use in this invention. However, polybutadiene can be added to the alloy, which mitigates some of the deficiencies found in MPUs based on polyester or polypropylene ether glycol.

The present invention is not limited to specific processes or additives. The examples set forth below employ methods and additives commonly used in the art. Processing methods, curing and additive packages typically used in the art for making rubber goods are described in “Blends of Polyurethane Rubbers with Conventional Rubbers”, Thomas L. Jablonowski, Rubber Division, American Chemical Society, Paper No. 46, Apr. 13-19, 1999. The reference describes a set of typical additives including N330 carbon black, dibutoxyethoxyethyl adipate (DBEEA) plasticizer, zinc stearate accelerator, stearic acid process aid, napthenic process oil, benzothiazyl isulfide (MBTS) accelerator, MBT 2-mercaptobenzothiazole accelerator, sulfur and tetramethyl thiuram disulfide (TMTD) accelerator.

### EXAMPLES

Exemplary embodiments of the present invention used PTMEG-based polyurethanes, Adiprene® CM (ACM) and Millathane® E-34 (ME34), and a polyester-based polyurethane, Millathane® M76 (MM76) (Adiprene and Millethane are trademarks of TSE Industries, Inc.). These polyurethanes are combined with rubbers to make the inventive alloys. Typically, the natural rubber and MPU are blended in e.g. Banbury mixer along with additives and curatives until thoroughly mixed to achieve desired consistency as described above. The natural rubbers employed are isoprene materials typically used in conventional sports balls.

### Examples 1-12

Alloys were formed by mixing either Adiprene® CM (ACM), Millathane® E-34 (ME34), or Millathane® M76 (MM76) with natural rubber components designated GP2 or GP4 in proportions indicated in the tables below. The MPU compositions included about 50% clay and other additives. As previously noted, GP2 and GP4 rubbers likewise included about 50% clay and other additives. The results of permeability testing is presented in the table below. Example alloys were made by milling together the natural rubber formulations with either ACM, ME34, or MM76 formulations. The various alloys were cured and tested for permeability. Table 1 below presents the properties of the cured samples. Table 2 presents permeability values and test conditions. Permeability results for conventional rubber formulations are provided as comparative examples. The data show that the novel alloys have improved gas retention with acceptably high resilience and strength. These data were taken in the presence of alloys comprising 50 weight % each of MPU and rubber. However, the ratio of MPU to rubber may be varied to suit specific applications.

Hardness tests were conducted in accordance with ASTM D2240. Resilience tests were conducted in accordance with ASTM D2632. Tests for tensile properties were conducted in accordance with ASTM D412. Permeability tests were conducted according to ASTM D1434.

TABLE 1

| | | | 100% | |
|---|---|---|---|---|
| | | | Tensile | Tensile |
| | Hardness | Resilience | Modulus | Strength |
| Description | Shore A | % | psi | Psi |
| 50/50 ACM/GP2 | 70 | 38 | 510 | 1692 |
| 50/50 ACM/GP4 | 70 | 36 | 445 | 1620 |
| 50/50 ME34/GP2 | 70 | 41 | 441 | 1361 |
| 50/50 ME34/GP4 | 68 | 39 | 445 | 1620 |
| 50/50 MM76/GP2 | 71 | 24 | 378 | 1149 |
| 50/50 MM76/GP4 | 69 | 22 | 386 | 1272 |

TABLE 2

| | | | | | | Oxygen | |
|---|---|---|---|---|---|---|---|
| | | Nominal | | | | Trans. | Est. Oxygen |
| | | Sample | Relative | | Pressure | Rate | Permeability |
| | | Thickness | Humidity | Temp. | Gradient | (21% 02) | Cc cm/cm2 |
| Example | Description | Mils | % | deg. C. | mm Hg | cc/m2 day | sec Pa 10⁻¹³ |
| 1. | 50/50 ACM/GP2 | 40 | 35 | 25 | 760 | 52 | 3.0 |
| 2. | 50/50 ACM/GP2 | 40 | 35 | 37 | 760 | 95 | 5.4 |
| 3. | 50/50ACM/GP4 | 42 | 35 | 25 | 760 | 60 | 3.4 |
| 4. | 50/50ACM/GP4 | 42 | 35 | 37 | 760 | 104 | 6.2 |
| A | GP2 | 38 | 35 | 25 | 760 | 96 | 5.1 |
| B | GP2 | 38 | 35 | 37 | 760 | 174 | 9.3 |
| C | GP4 | 43 | 35 | 25 | 760 | 95 | 5.8 |
| D | GP4 | 43 | 35 | 37 | 760 | 163 | 10.0 |
| 5. | 50/50 ME34/GP2 | 40 | 35 | 25 | 760 | 81 | 4.6 |
| 6. | 50/50 ME34/GP2 | 40 | 35 | 37 | 760 | 136 | 7.8 |
| 7. | 50/50 ME34/GP4 | 40 | 35 | 25 | 760 | 85 | 4.8 |
| 8. | 50/50 ME34/GP4 | 40 | 35 | 37 | 760 | 85 | 8.2 |
| 9. | 50/50 MM76/GP2 | 35 | 35 | 25 | 760 | 31 | 1.6 |
| 10. | 50/50 MM76/GP2 | 35 | 35 | 37 | 760 | 64 | 3.2 |
| 11. | 50/50 MM76/GP4 | 31 | 35 | 25 | 760 | 46 | 2.0 |
| 12. | 50/50 MM76/GP4 | 31 | 35 | 37 | 760 | 90 | 4.0 |

### Examples 13-24

Alloys of MPU and GP1, a natural rubber formulation including about 50% clay and other additives, gave improved permeability relative to controls GP2 and GP4 and showed a strong correlation of temperature and permeability. The materials were prepared as in Examples 1-12, but tested as sheets examples. Example E is a sheet example was made from GP1.

TABLE 3

| | | | | | | | Oxygen | |
|---|---|---|---|---|---|---|---|---|
| | | 290 F | Nominal | | | | Trans. | Est. Oxygen |
| | | Mill | Sample | Relative | | Pressure | Rate | Permeability |
| | | Time | Thickness | Humidity | Temp. | Gradient | (21% 02) | cc cm/cm2 |
| Example | Units | min | mils | % | deg. C. | mm Hg | cc/m2 day | sec Pa 10⁻¹³ |
| 13. | 20/80 | 10 | 34 | 35 | 25 | 760 | 106 | 5.1 |
| | ACM/GP1 | | | | | | | |
| 14. | 40/60 | 10 | 32 | 35 | 25 | 760 | 77 | 3.5 |
| | ACM/GP1 | | | | | | | |
| 15. | 60/40 | 10 | 43 | 35 | 25 | 760 | 40 | 2.5 |
| | ACM/GP1 | | | | | | | |
| 16. | 80/20 | 15 | 34 | 35 | 25 | 760 | 35 | 1.7 |
| | ACM/GP1 | | | | | | | |
| 17. | 80/20 | 15 | 27 | 35 | 25 | 760 | 51 | 2.0 |
| | ACM/GP1 | | | | | | | |
| 20. | 80/20 | 15 | 27 | 35 | 25 | 760 | 92 | 3.5 |
| | ME34/GP1 | | | | | | | |
| 21. | 20/80 | 10 | 33 | 35 | 25 | 760 | 115 | 5.5 |
| | ME34/GP1 | | | | | | | |
| 22. | 40/60 | 10 | 34 | 35 | 25 | 760 | 87 | 4.2 |
| | ME34/GP1 | | | | | | | |
| 23. | 60/40 | 10 | 42 | 35 | 25 | 760 | 64 | 3.8 |
| | ME34/GP1 | | | | | | | |
| 24. | 80/20 | 15 | 32 | 35 | 25 | 760 | 59 | 2.7 |
| | ME34/GP1 | | | | | | | |
| E | GP1 | 10 | 24 | 35 | 25 | 760 | 256 | 8.7 |

### Examples 25-26

Examples 25-26 were equivalent to Examples 13-24, except formed into core hemispheres and testing at significantly greater wall thicknesses. FIG. 1 illustrates oxygen permeability as a function of increasing weight percent MPU alloyed with GP1 conventional rubber tennis ball core formulation. The data of Table 4 are plotted as a function of MPU concentration. Permeability was determined at 25° C. and 35% relative humidity. The permeability of the various alloys exhibits a bi-phasic, asymptotic reduction with increasing MPU concentration. An inflection is observed in the vicinity of 30 to 40 weight percent MPU. The curve to the left of the inflection represents increasing cost-benefit ratios and lower cost alloys. The milling time, required to form usable mixtures increased as a function of MPU concentration. The milling time, in minutes, required to form a good mixture is designated by the labels “10”, “15” and “25.”

TABLE 4

| | | | | | | Oxygen | |
|---|---|---|---|---|---|---|---|
| | | Nominal | | | | Trans. | Est. Oxygen |
| | | Sample | Relative | | Pressure | Rate | Permeability |
| | | Thickness | Humidity | Temp. | Gradient | (21% 02) | Cc cm/cm2 |
| Example | Description | Mils | % | deg. C. | mm Hg | cc/m2 day | sec Pa 10⁻¹³ |
| 25. | 40/60 ACM/GP1 | 139 | 35 | 25 | 760 | 0.0633 | 2.7 |
| 26. | 40/60 | 144 | 35 | 25 | 760 | 0.1194 | 5.2 |
| | ME34/GP1 | | | | | | |

### Examples 27-28

These examples and comparative examples F and G demonstrate properties of the alloys with natural rubber GP1 in the form of a tennis ball. The materials were made as in Examples 13-24. The alloys comprised 40% ACM or ME34 with 60% GP1. The results of age studies for various properties of tennis balls are presented in Tables 5-7. Comparative Example F represents the state of-the-art in the form of a premium branded commercially available tennis ball designed and marketed for tennis professionals. Comparative Example G represents a tennis ball made from rubber formulation GP1.

TABLE 5
Tennis Ball Rebound

| | Rebound Change (in) | 14 days | 28 days | 42 days |
|---|---|---|---|---|
| F | Commercial Tennis Ball | −0.4 | −1.5 | −2.0 |
| G | GP1 | −0.5 | −1.0 | −2.0 |
| 27 | 40/60 ME34/GP1 ALLOY | −0.2 | −0.6 | −0.8 |
| 28 | 40/60 ACM/GP1 ALLOY | −0.1 | −0.3 | −0.8 |

TABLE 6
Tennis Ball Deflection

| | Deflection Change (in) | 14 days | 28 days | 42 days |
|---|---|---|---|---|
| F | Commercial Tennis Ball | 0.012 | 0.016 | 0.006 |
| G | GP1 | 0.006 | 0.009 | 0.016 |
| 27 | 40/60 ME34/GP1 ALLOY | −0.001 | −0.003 | −0.008 |
| 28 | 40/60 ACM/GP1 ALLOY | −0.002 | −0.002 | 0.000 |

TABLE 7
Tennis Ball Air Pressure

| | Air Pressure Change (psi) | 14 days | 28 days | 42 days |
|---|---|---|---|---|
| F | Commercial Tennis Ball | −1.2 | −2.7 | −3.2 |
| G | GP1 | −1.0 | −1.6 | −2.8 |
| 27 | 40/60 ME34/GP1 ALLOY | −0.4 | −1.3 | −1.7 |
| 28 | 40/60 ACM/GP1 ALLOY | −0.6 | −1.4 | −2.1 |

Tennis balls made from the inventive materials in examples 27 and 28 both exhibit good consistency in the balance of rebound, deflection and air pressure attributes over time. Destructive evaluation of core samples revealed deficiencies in seem adhesion resulting in compromised air retention. Rebound and deflection were measured in inches. Air pressure was measured in pounds per square inch (psi) using a standard destructive method described in U.S. Pat. No. 5,558,325.

Other inflated sporting goods are fabricated of these innovative alloys. Similar to tennis ball fabrication, basketballs, volleyballs, soccer balls and the like are made by preparing a milled gum which is fashioned into a pre-form, and then vulcanized in a mold under internal pressure. The key distinction with these thin walled inflated balls is that an inflation nipple is utilized. The pre-form is inflated within a hollow cavity during cure. The bladder is then covered with reinforced fiber windings and or a laminated leather, synthetic leather or rubber carcass. With all of these balls, similar alloys are employed. Another inflated rubber article, bike tire inner tubes, is made with a similar process, again, with an inflation valve, but without the fiber winding or carcass covering. Another inflated rubber article, tubeless bicycle tubes are constructed by multiple layer moldings, in which the novel alloys are expected to provide an enabling balance of low air permeability with low viscous heating with beneficial effect on wheel system rolling resistance as well.

What is claimed is:

1. A composition of matter suitable for forming gas-permeation barrier articles comprising substantially amorphous millable polyurethane alloyed with rubber.

2. The composition of matter according to claim 1, wherein said rubber is admixed with up to about 50% clay.

3. The composition of matter according to claim 1, wherein said composition has an oxygen permeability, at 25° C., not greater than about 5.5 cm³ cm/cm² seconds Pascal 10⁻¹³.

4. The composition of matter according to claim 1, wherein said millable polyurethane comprises an ether glycol selected from the group consisting of polytetramethylene ether glycol, polyester ether glycols, and polypropylene ether glycols.

5. The composition of matter according to claim 1, wherein said rubber is selected from the group consisting of polyisoprene, polybutadiene, and blends thereof.

6. The composition of matter according to claim 5, wherein said rubber is polyisoprene.

7. The composition of matter according to claim 5, wherein said polyisoprene is natural or synthetic.

8. The composition of matter according to claim 1, wherein said composition comprises at least 10 weight percent millable polyurethane.

9. The composition of matter according to claim 1, wherein said composition comprises at least 40 weight percent millable polyurethane.

10. The composition of matter according to claim 1, further comprising kaolin clay extender, barium ulphate density filler, silicon dioxide curative, phthalate ester process oil, zinc oxide cure, sulfur curative, n-tert-butyl2benxothiazolesulfenamide cure aide, diphenyl guanidine accleerator, dibasic zinc stearate cure aide, benzothiazyl disulfide accelerator, and zinc chloride/MBTS complex cure activator.

11. An inflatable article of manufacture comprising substantially amorphous millable polyurethane alloyed with rubber.

12. The inflatable article of manufacture according to claim 11, wherein said rubber is admixed with up to about 50% clay.

13. The inflatable article of manufacture according to claim 11, wherein said composition has an oxygen permeability, at 25° C., not greater than about 5.5 cm³ cm/cm² seconds Pascal 10⁻¹³.

14. The inflatable article of manufacture according to claim 11, wherein said millable polyurethane comprises an ether glycol selected from the group consisting of polytetramethylene ether glycol, polyester ether glycols, and polypropylene ether glycols.

15. The inflatable article of manufacture according to claim 11, wherein said rubber is selected from the group consisting of polyisoprene, polybutadiene, and blends thereof.

16. The inflatable article of manufacture according to claim 15, wherein said rubber is polyisoprene.

17. The inflatable article of manufacture according to claim 15, wherein said polyisoprene is natural or synthetic.

18. The inflatable article of manufacture according to claim 15, wherein said composition comprises at least 10 weight percent millable polyurethane.

19. The inflatable article of manufacture according to claim 11, wherein said composition comprises at least 40 weight percent millable polyurethane.

20. The inflatable article of manufacture according to claim 15, further comprising kaolin clay extender, barium ulphate density filler, silicon dioxide curative, phthalate ester process oil, zinc oxide cure, sulfur curative, n-tert-butyl2benxothiazolesulfenamide cure aide, diphenyl guanidine accleerator, dibasic zinc stearate cure aide, benzothiazyl disulfide accelerator, and zinc chloride/MBTS complex cure activator.

21. The inflatable article of manufacture according to claim 11, wherein said article is selected from the group consisting of balls, inner tubes, and tubeless tires.

22. The inflatable article of manufacture according to claim 11, wherein said inner tube is a bicycle inner tube.

23. A tennis ball comprising substantially amorphous millable polyurethane alloyed with rubber.

24. The tennis ball according to claim 23, wherein said rubber is admixed with up to about 50% clay.

25. The tennis ball according to claim 23, wherein said alloy has an oxygen permeability, at 25° C., not greater than about 5.5 cm³ cm/cm² seconds Pascal 10⁻¹³.

26. The tennis ball according to claim 23, wherein said millable polyurethane comprises an ether glycol selected from the group consisting of polytetramethylene ether glycol, polyester ether glycols, and polypropylene ether glycols.

27. The tennis ball according to claim 23, wherein said rubber is selected from the group consisting of polyisoprene, polybutadiene, and blends thereof.

28. The tennis ball according to claim 27, wherein said rubber is polyisoprene.

29. The tennis ball according to claim 28, wherein said polyisoprene is natural or synthetic.

30. The tennis ball according to claim 23, wherein said alloy comprises at least 10 weight percent millable polyurethane.

31. The tennis ball according to claim 23, wherein said alloy comprises at least 40 weight percent millable polyurethane.

32. The tennis ball according to claim 23, further comprising N330 carbon black, dibutoxyethoxyethyl adipate (DBEEA) plasticizer, zinc stearate accelerator, stearic acid process aid, napthenic process oil, benzothiazyl disulfide (MBTS) accelerator, 2-mercaptobenzothiazole (MBT) accelerator, sulfur and tetramethyl thiuram (TMTD)disulfide accelerator.
